(19) United States
(12) Patent Application Publication
(10) Pub. No.: US 2005/0198407 A1
(43) Pub. Date: Sep. 8, 2005

(54) USB CONNECTOR WITH CARD DETECTOR

(76) Inventor: Johnson Lee, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/906,744

(22) Filed: Mar. 4, 2005

(30) Foreign Application Priority Data
Mar. 4, 2004 (TW) 93203238

(51) Int. Cl. G06F 13/00

(52) U.S. Cl. 710/15

(57) ABSTRACT

A USB connector with a card detector suitable for a low power capacity system is provided. The USB connector comprises at least a power pad, a D− signal pad, a D+signal pad, a ground pad and a device insertion detecting pad. The device insertion detecting pad and the ground pad are disposed to correspond with the ground pad of an external USB interface device so that the device insertion detection pad and the ground pad are simultaneously grounded when the external device is inserted into the USB connector. The supply of power to the USB connector is controlled through the short-circuiting signal produced by the device insertion detection pad. The USB connector of the present invention can be applied to actuate a VBUS power converter circuit in a timely manner and drive the USB connector into a standard operation with very little power loss in an idling state when no external device is plugged into the USB connector.

### CROSS-REFERENCE TO RELATED APPLICATION

This application claims the priority benefit of Taiwan application serial no. 93203238, filed Mar. 4, 2004.

### BACKGROUND OF THE INVENTION

1. Field of the Invention

The present invention relates to an improved USB connector. More particularly, the present invention relates to an energy-efficient USB connector.

2. Description of the Related Art

To facilitate the linking of various external peripheral devices with different system terminals, four major international companies (including Compaq, Intel, Microsoft and NEC) have developed the Universal Serial Bus (USB) interface in 1998. Ever since Microsoft Windows 98 operating system started to provide built-in program for driving USB interface peripheral devices, the use of these peripheral products are facilitated. As a result, the applications of USB products have been expanding gradually.

In general, the USB interface uses differential serial signals to provide serial data in physical layer transmission. Furthermore, the USB interface deploys a list of multifarious and highly flexible communication protocols so that many types of devices are supported. The USB interface has many advantages including a small number of signal pads (only four signal pads including a power pad VBUS, a ground pad GND, a signal pad D+ and another signal pad D−), the provision of a power supply, a high transmission rate (categorizes into a low-speed 1.5 Mbit/sec, a full-speed 12 Mbit/sec and a high speed 480 Mbit/sec) and the possibility of hot plugging (the installation of expandable equipment does not require system shutdown or rebooting the machine). With so many advantages, USB products have gradually replaced the first generation expansion interface including the parallel ports and the serial ports in some older computer systems. At present, various types of USB peripheral products for collecting data, storing data, capturing/scanning image and printing documents are produced.

In the past, the USB interface was regarded as an add-on to a personal computer system for connecting with an external device. Since the USB interface was mainly designed to facilitate the operation of the personal computer, there is no way for two peripheral devices connected through the USB interface to exchange data with each other. Because of this, the USB-IF (the USB implementer Forum—an organization for implementing and developing USB standards) not only has developed USB standards for peripheral devices of computer systems, but also has provided the newly developed digital portable products including, for example, DSC, PDA, SmartPhone, with USB OTG standard. This new standard permits peripheral interface products to exchange data with each other according to a set of specified rules. Thus, portable devices may communicate with each other through a communicative control without the need for any mediation through a central computer system, which is a breakthrough in the application mode of portable devices. For example, a DSC may directly connect to a photo printer and a PDA may directly connect to a keyboard or a mouse.

In the design of a USB interface, the system terminals must rely on electrical variation in the signal lines D+ or D− to detect the presence of any externally plugged devices in the expansion interface. If no devices are plugged into the expansion interface, then the D+ and D− signal pad in the USB interface will have a potential close to zero. If a Low-Speed device is plugged into the expansion interface, the Low-Speed device will connect the D− signal pad to a 3.3V power source. Hence, the system terminal will detect the insertion of a Low-Speed device through the voltage variation in the D− signal line. If a Full-Speed device is plugged into the expansion interface, the Full-Speed device will connect the D+signal pad to a 3.3V power source. Thus, the system terminal will detect the insertion of a Full-Speed device through the voltage variation in the D+signal line. Finally, if a High-Speed device is plugged into the expansion interface, the external device will use the Full-Speed operating mode to inform the system terminal about the presence of a plugged Full-Speed device. Thereafter, through a software interface protocol, whether high-speed communication is supported by both side or not is verified. Only at the completion of the verification will the devices be switched to a High-Speed operating mode.

A system terminal with a USB interface must rely on the variation of electrical signal from the external device to detect the presence of a plugged external device as well as to determine the operational attributes. Hence, the characteristics of the electrical supply by the USB interface have to be repeatedly prompted through transmitting an operating voltage to the external device from the VBUS power pad so that the external device is prepared for pulling the D+/D− interface pad to a high potential. In brief, some of the electronic devices inside the system terminal have to operate even if no external device is plugged into the system. This means that electrically are constantly consumed and forever wasted.

The aforementioned design, when deployed to a desktop computer system or a notebook computer system connected to a fixed power source, permits the detection of any variation in the D+/D− signal in the system terminal at any time because an unlimited supply of power is provided. However, when the aforementioned design is applied to the aforementioned USB-OTG interface of a portable digital device (such as a PDA or a SmartPhone), which is provided with limited power due to bulk and weight considerations, too much power will be demanded from the power supply of the portable device.

FIGS. 1A-1C show an application circuit diagram of a portable device such as a PDA or a digital camera having a CF memory card serving as a storage device and a USB interface serving as a signal transmission center. The portable device can be connected to a printer with a USB interface for printing out internally stored data on paper at any time. The portable device has a USB connector (CONN2) for connecting to the USB interface of the printer and a USB interface controller (U2) for operating the USB connector (CONN2). To provide the external device in the USB connector (CONN2) with power and enable the portable device to determine the type of plugged external device, voltage converter circuits U4 and U3 electrically connected to the USB interface connector (CONN2) and the USB interface controller are installed inside the portable device. Furthermore, to ensure a suitable response when the external device is plugged and provide power to drive the external device, the voltage converters U4 and U3 inside the portable device must perform voltage conversion continuously to provide the internal devices with corresponding operating voltage. In the meantime, the voltage level of the external device must be constantly checked for any pull-up voltage to determine the type of plug-in device. Furthermore, power cannot be cut for the USB interface controller (U2) because it needs to be in a standby state at all times. In other words, power to the USB interface related circuits and controller inside the portable device must be provided even if no external device is attached.

In brief, the aforementioned phenomenon brings out a design quite contrary to our goal of producing a light-weight, power-efficient, low battery power capacity portable device. Since the operating period of the battery will be reduced due to constant power consumption, the in store period of the battery will be significantly shortened.

To combat the shortening of battery life due to the setup of a USB interface in the portable device, some specific issues need to be considered. For example, in the absence of any external device, power to some of the devices inside the portable device such as the voltage converter and the power supply can be cut off completely.

### SUMMARY OF THE INVENTION

Accordingly, at least one objective of the present invention is to provide a USB connector that can combat the shortening of battery life due to the setup of a USB system interface in a portable device.

At least a second objective of the present invention is to provide a USB connector having an additional device insertion detection mechanism that will not provide an external device operating voltage or power needed to drive a USB interface controller when no external device is inserted into the USB connector.

At least a third objective of the present invention is to provide a USB connector having an additional device insertion detection mechanism such that a portable device power source is turned on only after an external device has been inserted into the USB connector.

To achieve these and other advantages and in accordance with the purpose of the invention, as embodied and broadly described herein, the invention provides a USB connector. The USB connector can be disposed in a low power capacity system. The USB connector comprises at least a power pad, a D− signal pad, a D+signal pad, a ground pad and a device insertion detection pad. The device insertion detection pad and the ground pad are disposed to correspond with the ground pad of an external USB interface device so that the device insertion detection pad and the ground pad of the USB connector are simultaneously grounded when the external USB interface device is inserted into the USB connector. Hence, the supply of power to the USB connector is controlled through the device insertion detection pad.

Alternatively, the device insertion detection pad and the power pad may be disposed to correspond to the power pad of the external USB interface device so that the supply of power to the USB connector is controlled through the level transition in the device insertion detection pad.

The present invention also provides an application system with a USB connector. The application system comprises at least a USB connector and an application circuit. The USB connector comprises at least a power pad, a D− signal pad, a D+signal pad, a ground pad and a device insertion detection pad. The device insertion detection pad determines whether operation power needed to drive the external device is provided through the USB connector or not.

The application circuit comprises at least a power controller and a power converter circuit respectively connected to the device insertion detection pad. When the external USB interface device is inserted so that the device inserted detection pad is short-circuit to the ground to become a low potential, the device insertion detection pad generates an insertion control signal to drive the power controller and the power converter circuit. Thus, the USB connector and its corresponding USB interface controller are actuated to perform a standard operation process. Conversely, in the absence of any external USB interface controller in the USB connector, both the power controller and the power converter circuit will not receive any insertion control signal and hence remains in the shutdown state. Therefore, the USB connector and its corresponding USB interface controller will not be enabled.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A-1C show an application circuit diagram of the adapter of a conventional CF/USB interface storage device.

FIGS. 2A-2C show an application circuit diagram of the adapter of a CF/USB interface storage device according to one embodiment of the present invention.

FIG. 3 is a USB connector having an additional signal detection device according to one embodiment of the present invention.

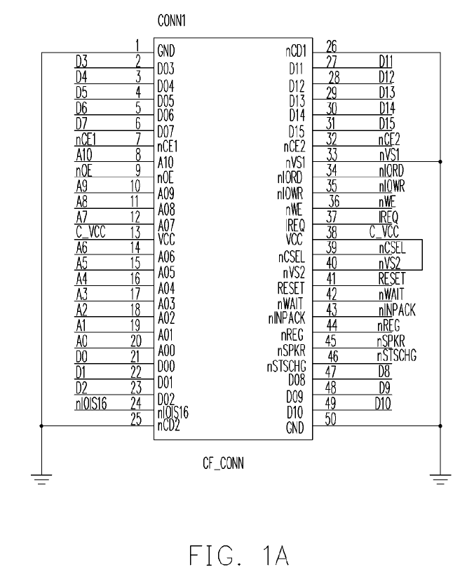

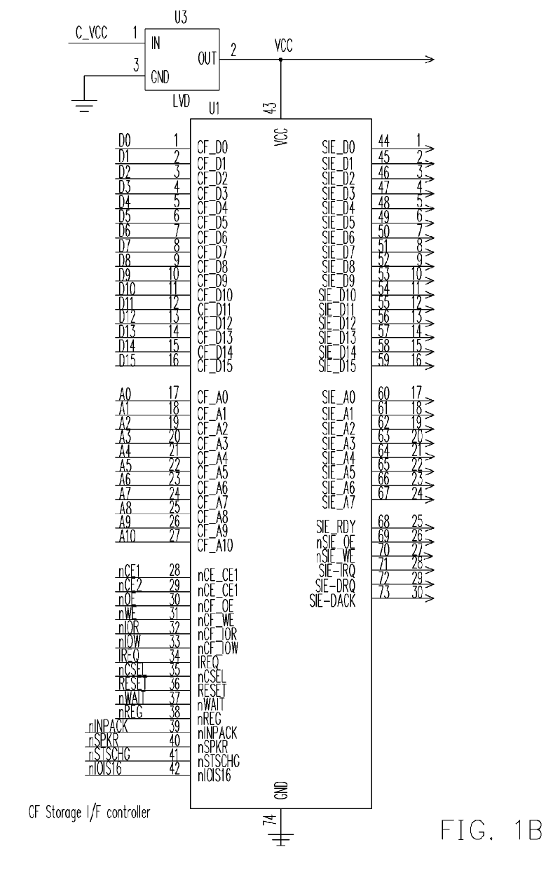

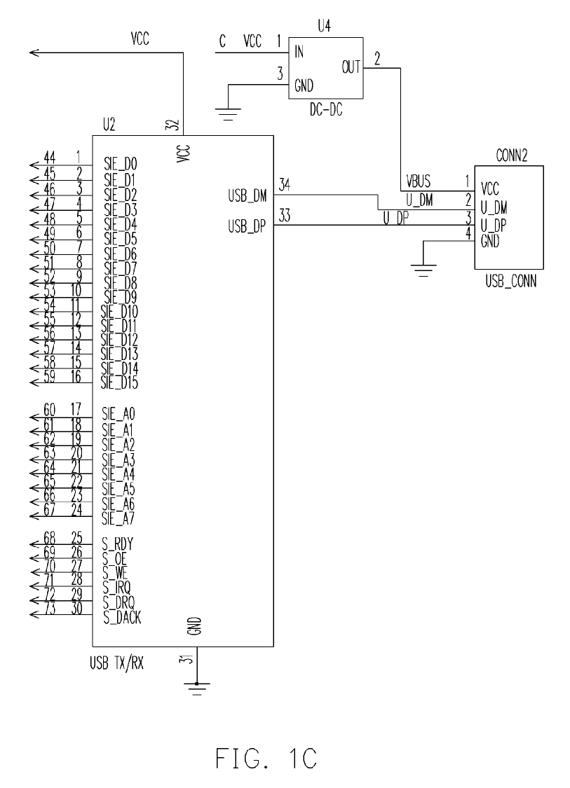

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the following, a system terminal device having a CF storage device interface and a USB transmission interface is used as an example to explain the characteristics and function of the present invention. The particular embodiment illustrates the method of implementing the present invention. However, anyone familiar with the technology may easily understand other advantages and performance of the present invention according to the content disclosed here. The present invention may also be implemented or applied through other different embodiments. In addition, the details in the present disclosure may be modified or changed according to individual viewpoint or application without departing from the spirit of the present invention.

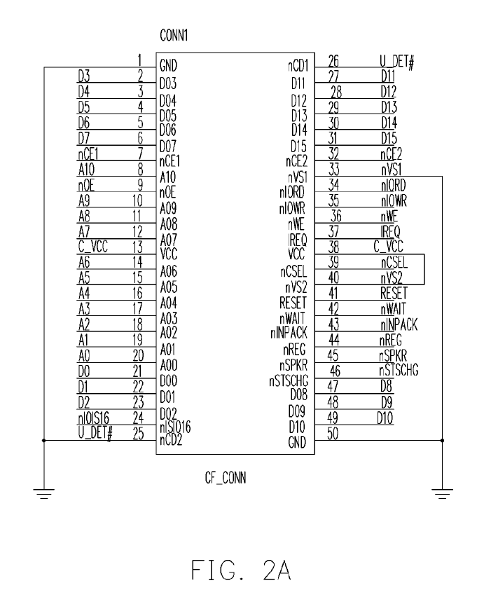

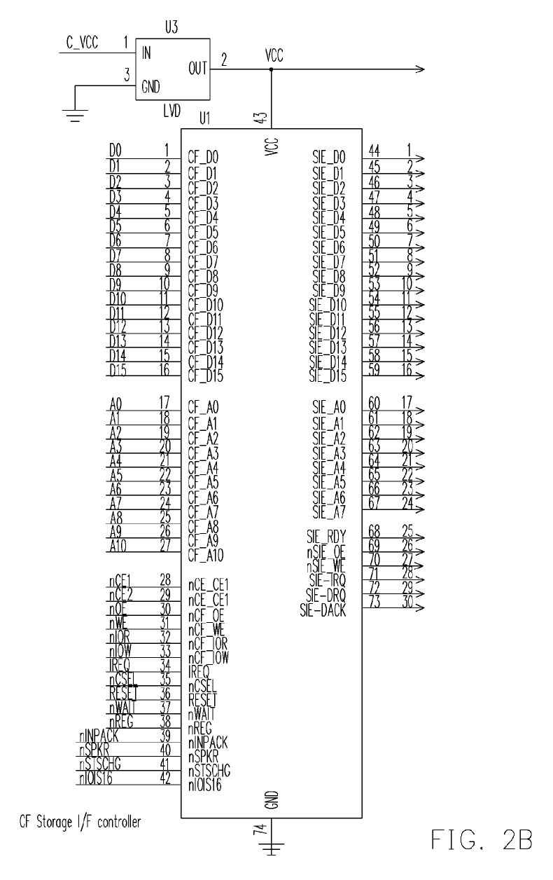

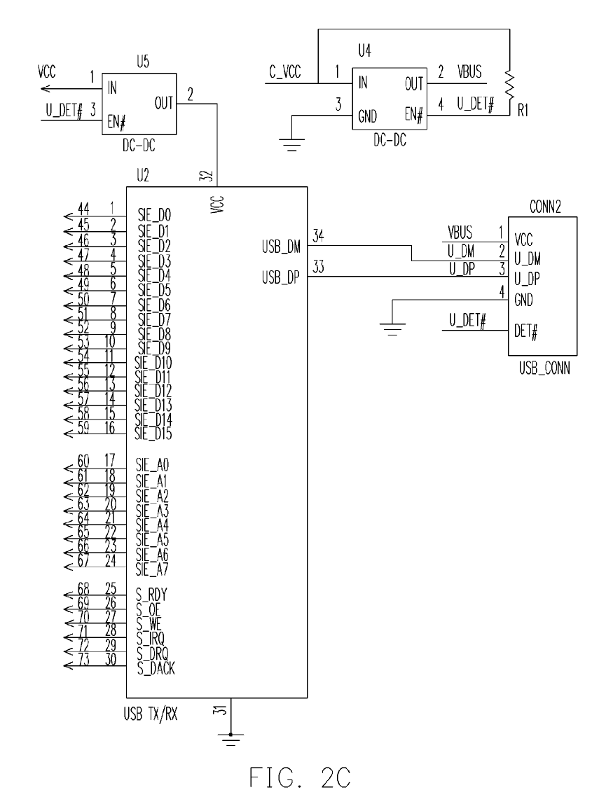

FIGS. 2A-2C show an application circuit diagram of a USB connector with an additional signal detection device according to one embodiment of the present invention. The USB connector of the present invention is embedded within the system terminal device. However, the “system terminal” is not limited to a computer host system. It also includes any external device with a USB connector such as a personal digital assistant (PDA) or a mobile phone.

The application circuit shown in FIGS. 2A-2C includes a CF interface storage device controller (U1), a USB interface controller (U2), a low voltage dropout (LVD) regulator (U3) for transforming a power source voltage to provide the voltage required by U1 and U2, a power converter circuit (U4), a power controller (U5), a CF interface storage device connector (CONN1) for achieving interface connection and a USB interface connector (CONN2). Since the CF interface storage device controller (U1) and the CF interface connector (CONN2) is related to the storage device of the system terminal device and is not a major concern in the present invention, a detailed description is omitted here.

In the present invention, signal transmissions are carried out through the electrical connection of the additional device insertion detection pad (115b) in the aforementioned USB connector with the power converter circuit (U4) and the power controller (U5) and the electrical connection of the D− and D+signal pad with the USB interface controller (U2). According to whether the device insertion detection pad (115b) is actuated or not, power necessary for operating the external device is provided by the USB connector (CONN2). The power controller (U5) is electrically connected to the USB interface controller (U2) and the power converter circuit (U4) is electrically connected to the power pad (110 of the USB connector (CONN2). When an external device is plugged so that the device insertion detection pad (115b) generates an insertion control signal to actuate the power controller (U5) and the power converter circuit (U4). Subsequently, the corresponding USB interface controller (U2) and the USB connector (CONN2) are actuated to perform a standard operation process.

In the absence of any external device plugged into the USB connector (CONN2), no insertion control signal are produced. Hence, the power controller (U5) and the power converter circuit (U4) remain in the original ‘shutdown’ state. As a result, the USB connector (CONN2) and its corresponding USB interface controller (U2) will not be enabled.

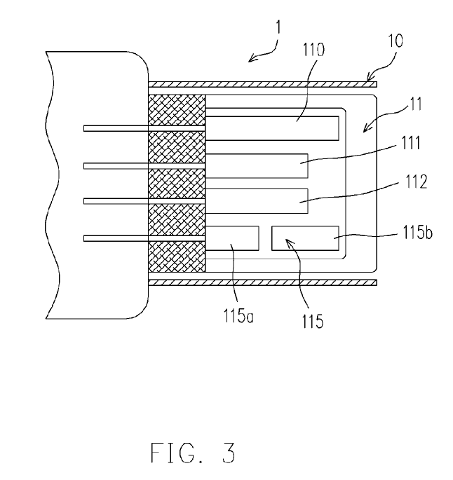

FIG. 3 is a USB connector having an additional signal detection device according to one embodiment of the present invention. As shown in FIG. 3, the USB connector 1 comprises a VBUS signal pad 110, a D− signal pad 111, a D+signal pad 112, a ground pad 115a and device insertion detection pad 115b. The VBUS signal pad 110, the D− signal pad 111, the D+signal pad 112 and the ground pad 115a are set up, from top to bottom, according to the USB standard specification. The ground pad 115a and the insertion detection pad 115b are disposed to correspond with the ground pad of an external device so that the insertion detection pad 115b can detect any plugged external device. When an external device (not shown) is plugged, the insertion detection pad 115b will generate a signal to inform the system terminal and actuate a USB interface module and a VBUS power source. Thereafter, the type of plugged external device is determined so that a standard operating mode is initiated. On the contrary, in the absence of any plugged external device, the insertion detection pad 115b drives the system terminal to shut down the VBUS power supply and reduce overall power consumption of the system.

After the USB connector 1 has verified the presence of an external device through the insertion detection pad 115b, the system is immediately informed to actuate the power converter circuit U4 for providing power to the power pad 110. Thus, the external device is provided with the power necessary for carrying out any electrical communication between the external device and the USB connector 1.

The provision of the signal detection device will not lead to any change in the USB standard specifications. In other words, as long as the ground pad and the device inserting detection pad of the USB connector match the location of the ground pad (GND) of a corresponding external device, power to the VBUS and USB connector can be controlled through the change in electric potential for detecting the presence of external device in the present invention. For example, in order to form a short circuit with the ground to produce a low potential in the insertion detection pad 115b and the ground pad 115a after the external device has plugged into the USB connector 1, the metallic film 115 that originally serves as a ground pad is divided into two. One part of the metallic film 115 serves as the ground pad 115a for the USB connector 1 while the other part of the metallic film 115 serves as the insertion detection section 115b. Using a similar operating principle, the detection of external device plugged into the USB interface 1 and the subsequent power provision is based on the information provided by the high/low transition of the electric potential.

It should be noted that the mechanical structure for implementing the device insertion detection pad in the present invention is not limited to the one above. Other structures or positioning that can produce a similar result can be used as well. For example, the device insertion detection pad can be a movable foil that can be pushed when an external device is inserted into the USB connector, thereby producing a detection signal to inform the system that an external device has been inserted.

In summary, both the newly added insertion detection pad and the ground pad (GND) are electrically connected to the ground pad of the external device. Hence, the application circuit will shut down the USB interface controller and the power transmitted from the USB connector in the absence of any plugged device in the USB connector. ON the other hand, after an external device has plugged into the USB connector, the application circuit will immediately actuate all related electronic devices to initiate a standard operation process.

Thus, the USB connector of the present invention can be applied to actuate a VBUS power converter circuit instantly and drive the USB connector into a standard operation process without causing any energy waste in the absence of any external device. In other words, the present invention is able to reduce the power consumed by the electronic devices associated with the USB connector and extend the useful life of a battery. Thus, the USB system with additional signal detection device and energy-saving function according to the present invention is suitable for any low power capacity portable device including mobile phone, PDA, Smart Phone, digital camera and so on.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A universal serial bus (USB) connector with a signal detection device that can be disposed inside a low power capacity system terminal device, the USB connector comprises at least a power pad, a D− signal pad, a D+signal pad, a ground pad and a device insertion detection pad, wherein the insertion detection pad and the ground pad are disposed to correspond with a ground pad of an external device so that the device insertion detection pad and the ground pad of the USB connector will be simultaneously short-circuited to the ground due to the ground pad of the external device when the external device is inserted into the USB connector, and hence control the power provided by the USB connector or not.

2. The USB connector of claim 1, wherein the ground pad and the insertion detection pad is a cutout of the metallic foil that originally serves as a ground terminal.

3. An application system with a universal serial bus (USB) connector and a USB interface controller, the application system comprises:
a USB connector having at least a power pad, a D− signal pad, a D+signal pad, a ground pad and a device insertion detection pad, wherein the D− and D+signal pad are electrically connected to the USB interface controller to carry out signal transmissions, and the actuation of the device insertion detection pad determines whether the USB connector will provide power necessary to drive the external device or not; and
an application circuit, having at least:
a power controller electrically connected to the device insertion detection pad and the USB interface controller; and
a power converter circuit electrically connected to the device insertion detection pad and the power pad such that the device insertion detection pad will generate an insertion control signal in the presence of a plugged external device to actuate the power controller and the power converter circuit and hence actuate the corresponding USB interface controller and USB connector to perform a standard operation process.

4. The application system of claim 3, wherein the ground pad and the insertion detection pad is a cutout of the metallic foil that originally serves as a ground terminal.
